(19) United States
(12) Patent Application Publication
(10) Pub. No.: US 2025/0035146 A1
(43) Pub. Date: Jan. 30, 2025

(54) RADIAL FIT BOLT ASSEMBLY

(71) Applicant: Pilgrim International Ltd., Oldham (GB)

(72) Inventor: David CHARLES, Oldham (GB)

(21) Appl. No.: 18/775,318

(22) Filed: Jul. 17, 2024

(30) Foreign Application Priority Data
Jul. 24, 2023 (DE) 102023207028.6

(51) Int. Cl. F16B 31/04

(52) U.S. Cl. CPC F16B 31/043

(57) ABSTRACT

A radial fit bolt assembly includes a bolt having first and second sections with increasing diameter along a first direction, and an intermediate section axially interposed between the first and second sections. A sleeve radially surrounds the bolt and includes first and second sections with increasing inner diameter along the first direction, and an intermediate section axially interposed between the sleeve first and second sections. The first and second sections of the bolt are in radial contact respectively with the first and second sections of the sleeve, an annular gap is defined radially between the outer surface of the intermediate section of the bolt and the inner surface of the intermediate section of the sleeve, and an annular groove is provided on the outer surface of the intermediate section of the sleeve.

### CROSS-REFERENCE

This application claims priority to German patent application no. 102023207028.6 filed on Jul. 24, 2023, the contents of which are fully incorporated herein by reference.

### BACKGROUND OF THE INVENTION

The present invention relates to fasteners, and more particularly to bolt assemblies for coupling elements, especially for rotating applications, for example in slow rotating applications such as marine propulsion shaft flanged couplings or high-speed applications such as steam or gas turbine flanges couplings in the power generation sector.

Generally, a rotor shaft is coupled to a driving shaft by using two flanges provided with aligned through holes and fastened together with conventional fit bolts and nuts. To provide a coupling which does not require frequent bolt replacement and hole preparation as is the case with conventional fitted bolts, radial fit bolts were previously provided.

Generally, a radial fit bolt comprises a bolt with a tapered body surrounded by a sleeve with complementary tapered inner surface. The bolt further comprises two threaded heads at each extremity of the tapered body for fitting nuts. To tighten the bolt inside the sleeve, an axial pressure is applied to each of the two heads of the bolt.

In certain applications, in particular applications with reduced clearance, the load required to tighten the bolt exceeds the load limit that can be applied to the threaded heads of the bolt, making the installation of the bolt impossible.

### SUMMARY OF THE INVENTION

The aim of the present invention is to solve the problems indicated above, and to provide a bolt assembly for fast and trouble-free installation and removal, to avoid seized bolts and associated unplanned costs and to provide a solution for vibration issues.

The present invention concerns a radial fit bolt assembly provided with:
a bolt comprising a first section and a second section both with increasing outer diameter along a first direction, and an intermediate section axially interposed between the first and second sections of the bolt, the outer diameter of the first section of the bolt being smaller than the outer diameter of the second section of the bolt; and
a sleeve radially surrounding the bolt and comprising a first section and a second section both with increasing inner diameter along the first direction, the first and second sections having the same outer diameter, the sleeve further comprising an intermediate section axially interposed between the first and second sections, the inner diameter of the first section of the sleeve being smaller than the inner diameter of the second section of the sleeve, the first and second sections of the bolt being in radial contact respectively with the first and second sections of the sleeve, the intermediate section of the sleeve surrounding radially at least partially the intermediate section of the bolt.

According to a general feature of the present invention, an annular gap is radially provided or defined between the outer surface of the intermediate section of the bolt and the inner surface of the intermediate section of the sleeve.

According to another general feature, an annular groove is provided on the outer surface of the intermediate section of the sleeve.

The radial force exerted by the bolt onto the sleeve when the bolt is tightened into the sleeve is transmitted radially from the first section of the bolt to the first section of the sleeve and from the second section of the bolt to the second section of the sleeve.

The annular gap reduces the required load on the bolt to tightening the bolt inside the sleeve and the annular groove enables the intermediate section of the sleeve to move radially outward while tightening the bolt inside the sleeve and radially inward while removing the bolt from the sleeve.

The annular gap radially provided between the outer surface of the intermediate section of the bolt and the inner surface of the intermediate section of the sleeve may extend axially on all the length of the intermediate section of the bolt. The annular gap may extend axially from the first section of the bolt to the second section of the bolt.

The annular gap radially provided between the outer surface of the intermediate section of the bolt and the inner surface of the intermediate section of the sleeve may extend axially on all the length of the intermediate section of the sleeve.

The annular groove provided on the outer surface of the intermediate section of the sleeve may extend axially on all the length of the intermediate section of the sleeve. The annular groove may extend axially from the first section of the sleeve to the second section of the sleeve.

At least one slit may be formed on the bottom surface of the annular groove provided on the outer surface of the intermediate section of the sleeve.

The slit reduces the force needed to deform radially the intermediate section of the sleeve. The slit may extend entirely axially.

The length of the sleeve may be at least 4.5 times the maximum diameter of the bolt.

The bolt may further comprise an inner injection channel provided with at least an axial main channel, with a first radial auxiliary channel opening on the outer surface of the first section of the bolt and with a second radial auxiliary channel opening on the outer surface of the second section of the bolt.

The first section of the bolt may comprise at least one groove formed on the outer surface of the bolt, the first radial auxiliary channel of the inner injection channel being open on the groove of the first section of the bolt.

The second section of the bolt may comprise at least one groove formed on the outer surface of the bolt, the second radial auxiliary channel of the inner injection channel being open on the groove of the second section of the bolt.

### BRIEF DESCRIPTION OF THE SEVERAL VIEWS OF THE DRAWINGS

Other advantages and features of the invention will appear from the detailed description of embodiments of the invention, which are non-limiting examples, illustrated on the appended drawings of which:

FIG. 1 is an axial cross-section view of two elements coupled by a radial fit bolt assembly according to an example of the invention,

FIG. 2 is a detail view of FIG. 1; and

FIG. 3 is a frontal view of the sleeve of FIG. 1.

### DETAILED DESCRIPTION OF THE INVENTION

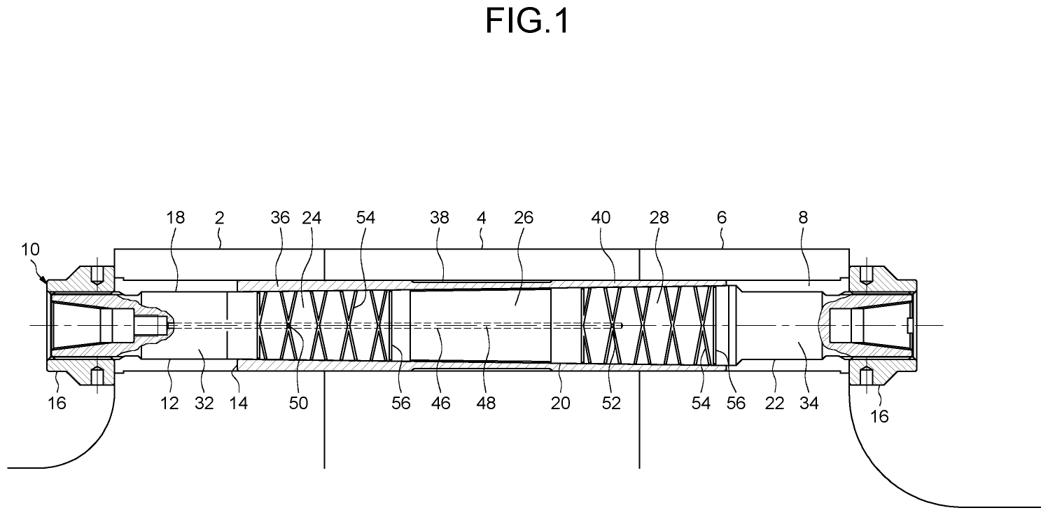

FIG. 1 shows a device, for example a rotor, comprising two elements 2, 4 enclosing a third element 6, each element 2, 4, 6 having aligned through holes 8. The elements 2, 4, 6 are coupled by a radial fit bolt assembly 10 extending through the aligned through holes 8 of the elements 2, 4, 6.

The radial fit bolt assembly 10 basically comprises a bolt 12, a sleeve 14 and two nuts 16. The bolt 12 includes, in this order, a first head section 18, a body 20 and a second head section 22.

The body 20 of the bolt 12 includes three sections: a first tapered section 24, an intermediate section 26 and a second tapered section 28. More specifically, the first tapered section 24 has an increasing outer diameter along a first direction, the smallest diameter of the first tapered section 24 of the body 20 extending axially from the first head section 18 of the bolt 12. The intermediate section 26 extends axially from the largest diameter of the first tapered section 24 of the body 20. The second tapered section 28 has an increasing outer diameter along the first direction, the smallest diameter of the second tapered section 28 extending axially from the intermediate section 26 of the body 20. The second tapered section 28 of the body 20 is axially opposed to the first tapered section 24 of the body 20, the largest diameter of the second tapered section 28 of the body 20 extending axially from the second head section 22 of the bolt 12.

In the present embodiment, the length (i.e., axial length) of the first section 24 of the body 20 equals the length of the second section 28 of the body 20, the length of the intermediate section 26 of the body 20 being smaller or less than the length of the first section 24 of the body 20. Alternatively, the length of the first section 24 of the body 20 may be different than the length of the second section 28 of the body 20. In a variant, the length of the intermediate section 26 of the body 20 may be greater than the length of the first section 24 of the body 20 and/or greater than the length of the second section 28 of the body 20.

The body 20 of the bolt 12 has a generally tapered shape (i.e., the body 20 generally tapers along a central axis), the outer surface of the first section 24 of the body 20 being in the axial prolongation of the outer surface of the second section 28 of the body 20, the outer diameter of the first section 24 of the body 20 being smaller or less than the outer diameter of the second section 28 of the body 20.

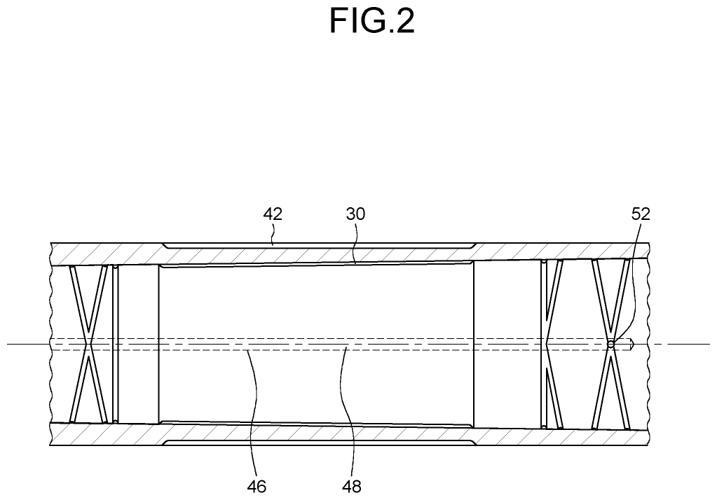

As seen more clearly in FIG. 2, an annular groove 30 is provided on the outer surface of the intermediate section 26 of the body 20, for example formed by machining, to reduce the outer diameter of the intermediate section 26 of the body 20, the outer surface of the intermediate section 26 of the body 20 being radially inward the axial prolongation of the outer surface of the second section 28 of the body 20. The bottom surface of the annular groove 30 provided on the outer surface of the intermediate section 26 of the body 20 is tapered in the axial direction. The annular groove 30 is preferably provided on the entire length of the outer surface of the intermediate section 26 of the body 20 and is axially delimited by the first section 24 of the body 20 on one end and by the second section 28 of the body 20 on the other end.

The first and second head sections 18, 22 of the bolt 12 each include an exterior thread (not represented) for engaging with each one of the two nuts 16. The first head section 18 includes a cylindrical section 32 extending axially from the smallest or least diameter (i.e., the outer diameter with the least value) of the first section 24 of the body 20. The second head section 22 includes a cylindrical section 34 extending axially from the largest or greatest diameter (i.e., the outer diameter with the greatest value) of the second section 28 of the body 20. Further, the cylindrical section 34 of the second head section 22 has the same outer diameter as the cylindrical section 32 of the first head section 18; in other words, the outer diameter of the cylindrical head section 34 has the same value as the outer diameter of the cylindrical head section 32.

The sleeve 14 includes three sections: a first section 36, an intermediate section 38 and a second section 40. The first section 36 of the sleeve 14 has an outer cylindrical surface and a tapered inner surface with increasing inner diameter along the first direction. The intermediate section 38 of the sleeve 14 extends axially from the smallest or least thickness of the first section 36 of the sleeve 14 and has a tapered inner surface with increasing inner diameter along the first direction. The second section 40 has an outer cylindrical surface with a diameter equal to the diameter of the outer cylindrical surface of the first section 36 of the sleeve 14 and a tapered inner surface with increasing inner diameter along the first direction, the largest or greatest thickness of the second section 40 of the sleeve 14 extending axially from the intermediate section 38 of the sleeve 14, the second section 40 of the sleeve 14 being axially opposed to the first section 36 of the sleeve 14.

In the present embodiment, the length (i.e., axial length) of the first section 36 of the sleeve 14 preferably equals the length of the second section 40 of the sleeve 14, the length of the intermediate section 38 of the sleeve 14 being smaller or less than the length of the first section 36 of the sleeve 14. Alternatively, the length of the first section 36 of the sleeve 14 may be different than the length of the second section 40 of the sleeve 14. In variant, the length of the intermediate section 38 of the sleeve 14 may be larger than the length of the first section 36 of the sleeve 14 or than the length of the second section 40 of the sleeve 14.

The tapered inner surface of the first section 36 of the sleeve 14 is in the axial prolongation of the tapered inner surface of the second section 40 of the sleeve 14, the outer diameter of the first section 36 of the sleeve 14 being smaller or less than the outer diameter of the second section 40 of the sleeve 14. The tapered inner surface of the intermediate section 38 of the sleeve 14 is in the axial prolongation of the tapered inner surface of the second section 40 of the sleeve 14.

An annular groove 42 is provided on the outer surface of the intermediate section 38 of the sleeve 14, for example formed by machining, such that the outer diameter of the intermediate section 38 of the sleeve 14 smaller or less than the outer diameter of the outer cylindrical surface of the second section 40 of the sleeve 14. The bottom surface of the annular groove 42 formed on the outer surface of the intermediate section 38 of the sleeve 14 is cylindrical. The annular groove 42 is provided along the entire length of the outer surface of the intermediate section 38 of the sleeve 14 and is axially delimited by the first section 36 of the sleeve 14 on one end and by the second section 40 of the sleeve 14 on the other end.

The sleeve 14 radially surrounds the body 20 of the bolt 12 and the length of the sleeve 14 is at least 4.5 times the maximum diameter of the bolt 12. More precisely, the length of the sleeve 14 is at least 4.5 times the diameter of the aligned through holes 8. The first section 36 of the sleeve 14 is in radial contact with the first section 24 of the body 20 of the bolt 12, the second section 40 of the sleeve 14 is in radial contact with the second section 28 of the body 20 of the bolt 12, and the intermediate section 38 of the sleeve 14 radially surrounds the intermediate section 26 of the body 20 of the bolt 12 without contact. As such, an annular gap is defined radially between the intermediate section 38 of the sleeve 14 and the intermediate section 26 of the body 20 of the bolt 12. Further, the inner surface of the first section 36 of the sleeve 14 has the same slope as the outer surface of the first section 24 of the body 20 and the inner surface of the second section 40 of the sleeve 14 has the same slope as the outer surface of the second section 28 of the body 20. As a result, the force exerted by the first section 24 of the body 20 on the first section 36 of the sleeve 14 is homogeneous or uniform and equals the force exerted by the second section 28 of the body 20 on the second section 40 of the sleeve 14.

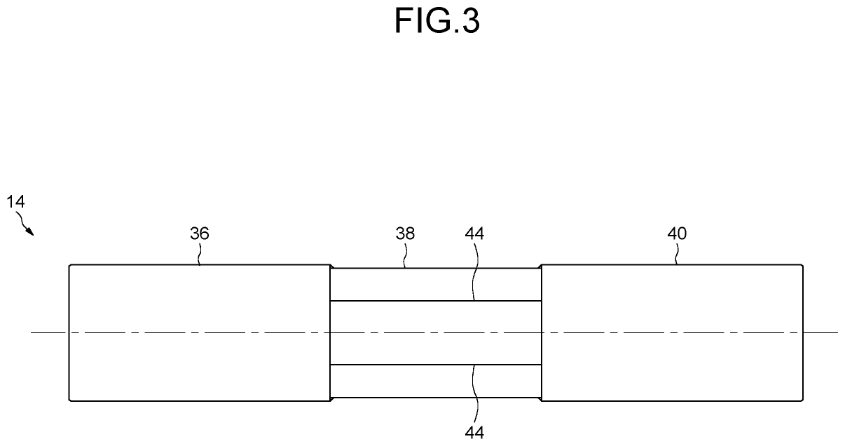

As seen more clearly in FIG. 3, a plurality of slits 44 are formed on the bottom surface of the annular groove 42 provided on the outer surface of the intermediate section 38 of the sleeve 14. In other words, the slits 44 extends radially inwardly from a surface of the intermediate section 38 which at least partially defines the annular groove 42. Each slit 44 extends axially along the entire length of the annular groove 42, and in the present embodiment, each slit 44 extends entirely axially (i.e., the slits 44 do not also extend circumferentially). The slits 44 assist in the radially outward expansion of the intermediate section 38 of the sleeve 14 when the bolt 12 is tightened inside the sleeve 14. Alternatively, the slits 44 may extend axially along less than the entire length of the groove 42, for example, along only 80% of the length of the groove 42.

Referring again to FIGS. 1 and 2, the bolt 12 includes an inner injection channel 46 provided for injecting a lubricant, such as oil, an axial main channel 48, a first radial auxiliary channel 50 opening on the outer surface of the first section 24 of the body 20 and on the axial main channel 48 and a second radial auxiliary channel 52 opening on the outer surface of the second section 28 of the body 20 and on the axial main channel 48. The axial main channel 48 extends from a first extremity or end of the bolt 12 situated on the side of the first head section 18 of the bolt 12 to at least one-third (⅓) of the second section 28 of the body 20.

Two grooves 54 are provided on the outer surface of the first section 24 of the body 20. More specifically, the two grooves 54 are each formed as a helical shape extending on the outer surface of the first section 24 of body 20, the grooves 54 having opposing helicity so as to form X-shaped grooves 54 on the outer surface of the first section 24 of the body 20. Two annular grooves 56 are also provided on the outer surface of the first section 24 of the body 20 enclosing axially and communicating with the two helical grooves 54. The first section 36 of the sleeve 14 radially surrounds the annular grooves 56 provided in the first section 24 of the body 20.

The first radial auxiliary channel 50 of the inner injection channel 46 opens in the middle of a X-shaped groove formed by the two helical grooves 54 provided on the first section 24 of the body 20. Thus, the lubricant injected by the first radial auxiliary channel 50 flows within both helical grooves 54 and to both annular grooves 56 and lubricates the interface between the first section 24 of the body 20 and the first section 36 of the sleeve 14.

Two grooves 54 are also provided on the outer surface of the second section 28 of the body 20. More specifically, the two grooves 54 are each formed as a helical shape extending on the outer surface of the first section 24 of body 20, the grooves 54 having opposing helicity so as to form X-shaped grooves 54 on the outer surface of the first section 24 of the body 20. Two annular grooves 56 are also provided on the outer surface of the second section 28 of the body 20 enclosing axially and communicating with the two helical grooves 54. The second section 40 of the sleeve 14 radially surrounds the annular grooves 56 provided in the second section 28 of the body 20.

The second radial auxiliary channel 52 of the inner injection channel 46 opens in the middle of a X-shaped groove 54 formed by the two helical grooves 54 provided in the second section 28 of the body 20. Thus, the lubricant injected by the second radial auxiliary channel 52 flows within both of the helical grooves 54 and to both annular grooves 56 and lubricates the interface between the second section 28 of the body 20 and the second section 40 of the sleeve 14.

As previously described, in the example depicted in FIGS. 1-3, an annular groove 30 is provided on the outer surface of the intermediate section 26 of the body 20. Alternatively, the intermediate section 26 of the body 20 may have a tapered outer surface in the axial prolongation of the outer surface of the second section 28 of the body 20 and an annular groove may be provided on the inner surface of the intermediate section 38 of the sleeve 14. Preferably, the annular groove on the inner surface section 38 extends along the entire length of the inner surface of the intermediate section 38 of the sleeve 14 and is axially delimited by the first section 36 of the sleeve 14 on one end and by the second section 40 of the sleeve 14 on the other end, thus also providing a radial annular gap between the intermediate section 38 of the sleeve 14 and the intermediate section 26 of the body 20. In another variant, both an annular groove 30 on the outer surface of the intermediate section 26 of the body 20 and an annular groove on the inner surface of the intermediate section 38 of the sleeve 14 may be provided.

A preferred assembly process of the radial fit bolt assembly 10 inside aligned through holes 8 is described as follows. In a positioning step, both the sleeve 14 and the bolt 12 are positioned into or inserted through the aligned through holes 8 in a clearance condition.

In a tightening step, the bolt 12 is tightened inside the sleeve 14 using hydraulic tooling, the sleeve 14 expanding while drawing the bolt 12 through the sleeve 14 to provide a radial interference fit between the bore of the aligned through holes 8 and the radial fit bolt 12 assembly 10. The annular groove provided 30 on the outer surface of the intermediate section 26 of the body 20 or on the inner surface on the intermediate section 38 of the sleeve 14 facilitates the drawing of the bolt 12 through the sleeve 14, while the annular groove 42 provided on the outer surface of the intermediate section 38 of the sleeve 14 enables the intermediate section 38 of the sleeve 14 to expand outward to create a radial fit.

After the sleeve 14 has expanded to create a radial fit, the two nuts 16 are then positioned. Using hydraulic tooling to apply tension on one nut 16, the radial fit bolt 12 is then subject to an axial stretch, the pressure is then held and the nut 16 tightened to create a clamping load.

The following description concerns a disassembly process of the radial fit bolt assembly 10 from aligned through holes 8. In a loosening step, the hydraulic tooling applies tension on one nut 16 to enable the nut 16 to be loosened.

In a lubrication step, a lubricant is injected into the inner injection channel 46, the lubricant flowing by the first radial auxiliary channel 50 to lubricate the interface between the first section 24 of the body 20 and the first section 36 of the sleeve 14 and flowing by the second radial auxiliary channel 52 to lubricate the interface between the second section 28 of the body 20 and the second section 40 of the sleeve 14.

In a removing step, the bolt 12 is removed from the sleeve 14, the annular groove 30 provided on the outer surface of the intermediate section 26 of the body 20 or on the inner surface on the intermediate section 38 of the sleeve 14 and the annular groove 42 provided on the outer surface of the intermediate section 38 of the sleeve 14 enabling a reduction of the diameter of the intermediate section 38 of the sleeve 14.

If the oil injection method is unsuccessful, then by removing the nut 16 from the opposite side, the sleeve 14 can be mechanically pushed off the radial fit of the bolt 12 by using hydraulic tooling.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A radial fit bolt assembly comprising:
a bolt including a first section, a second section and an intermediate section axially interposed between the first and second sections, the first section having an outer diameter increasing in a first direction and the second section having an outer diameter increasing in the first direction, the outer diameter of the first section being smaller than the outer diameter of the second section; and
a sleeve radially surrounding the bolt and including a first section, a second section and an intermediate section axially interposed between the first section of the sleeve and the second section of the sleeve, the first section of the sleeve having an inner diameter increasing along the first direction and the second section of the sleeve having an inner diameter increasing along the first direction, the first and second sections of the sleeve having the same outer diameter, the inner diameter of the first section of the sleeve being smaller than the inner diameter of the second section of the sleeve, the first section of the bolt being in radial contact with the first section of the sleeve and the second section of the bolt being in radial contact with the second section of the sleeve, the intermediate section of the sleeve at least partially radially surrounding the intermediate section of the bolt such that an annular gap is defined radially between an outer surface of the intermediate section of the bolt and an inner surface of the intermediate section of the sleeve and an annular groove is provided on an outer surface of the intermediate section of the sleeve.

2. The radial fit bolt assembly according to claim 1, wherein the intermediate section of the bolt has an axial length and the annular gap extends axially along the entire axial length of the intermediate section of the bolt.

3. The radial fit bolt assembly according to claim 1, wherein the intermediate section of the sleeve has an axial length and the annular groove extends axially along the entire axial length of the intermediate section of the sleeve.

4. The radial fit bolt assembly according to claim 1, wherein the intermediate section of the sleeve has a surface at least partially defining the annular groove of the intermediate section of the sleeve and at least one slit is extends radially inwardly from the surface of the annular groove of the intermediate section of the sleeve.

5. The radial fit bolt assembly according to claim 1, wherein a length of the sleeve is at least 4.5 times a maximum diameter of the bolt.

6. The radial fit bolt assembly according to claim 1, wherein the bolt further includes an inner injection channel having at least an axial main channel, a first radial auxiliary channel opening on an outer surface of the first section of the bolt and a second radial auxiliary channel opening on an outer surface of the second section of the bolt.

7. The radial fit bolt assembly according to claim 6, wherein:
the first section of the bolt includes at least one groove formed on an outer surface of the bolt, the first radial auxiliary channel of the inner injection channel being open on the at least one groove of the first section of the bolt; and
the second section of the bolt includes at least one groove formed on an outer surface of the bolt, the second radial auxiliary channel of the inner injection channel being open on the at least one groove of the second section of the bolt.
